(19) United States
(12) Patent Application Publication
(10) Pub. No.: US 2026/0332661 A1
(43) Pub. Date: Oct. 22, 2026

(54) TRIGGERING CLIENT DATA PROCESSING

(71) Applicant: Lenovo (United States) Inc., Morrisville, NC (US)

(72) Inventor: Roozbeh Atarius, La Jolla, CA (US)

(73) Assignee: Lenovo (United States) Inc., Morrisville, NC (US)

(21) Appl. No.: 19/297,498

(22) Filed: Aug. 12, 2025

(51) Int. Cl. H04L 67/02

(52) U.S. Cl. CPC H04L 67/02

(57) ABSTRACT

Various aspects of the present disclosure relate to triggering client data processing. A network entity (e.g., an artificial intelligence machine learning enablement (AIMLE) server) transmits a hypertext transfer protocol (HTTP) request to a device (e.g., an AIMLE client) associated with processing client data. In some cases, the HTTP request includes a command, such as a POST command, that indicates a custom operation for triggering processing of the client data. In some other cases, the HTTP request includes a command, such as a GET command, that indicates a non-custom operation for triggering the processing of the client data. The device processes the client data according to the request and transmits a response to the network entity that indicates an outcome of the processing of the client data.

### TECHNICAL FIELD

The present disclosure relates to wireless communications, and more specifically to data processing.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The network entity (e.g., an artificial intelligence machine learning enablement (AIMLE) server), the device (e.g., an AIMLE client, including a UE or an NE), processors, and methods of the present disclosure each have several innovative aspects, no single one of which is solely responsible for the desirable features disclosed herein.

A network entity (e.g., an AIMLE server) for wireless communication is described. The network entity may be configured to, capable of, or operable to perform one or more operations as described herein. For example, the network entity may be configured to, capable of, or operable to transmit a hypertext transfer protocol (HTTP) request associated with client data, where the HTTP request indicates a custom operation for triggering processing of the client data or a non-custom operation for triggering the processing of the client data, and receive a response to the HTTP request that indicates an outcome of the processing of the client data.

A processor (e.g., a standalone processor chipset, or a component of a network entity) for wireless communication is described. The processor may be configured to, capable of, or operable to perform one or more operations as described herein. For example, the processor may be configured to, capable of, or operable to transmit an HTTP request associated with client data, where the HTTP request indicates a custom operation for triggering processing of the client data or a non-custom operation for triggering the processing of the client data, and receive a response to the HTTP request that indicates an outcome of the processing of the client data.

A method performed or performable by a network entity for wireless communication is described. The method may include transmitting an HTTP request associated with client data, where the HTTP request indicates a custom operation for triggering processing of the client data or a non-custom operation for triggering the processing of the client data, and receiving a response to the HTTP request that indicates an outcome of the processing of the client data.

In some implementations of the network entity, the processor, and the method described herein, the network entity, the processor, and the method may further be configured to, capable of, or operable to trigger the processing of the client data, where the HTTP request indicates for the processing of the client data to include at least one of preparation of the client data or analysis of the client data. In some implementations of the network entity, the processor, and the method described herein, the response to the HTTP request indicates one or more of that the processing of the client data is successful, that the processing of the client data has failed and a corresponding error code, a notification that the processing of the client data is redirected to an additional device, processed client data, or a timestamp associated with the processing of the client data. In some implementations of the network entity, the processor, and the method described herein, the HTTP request includes a POST command, and where the custom operation is based on the HTTP request being the POST command. In some implementations of the network entity, the processor, and the method described herein, the POST command indicates one or more of a type of the client data, a client data preparation criterion, a client data analysis criterion, one or more schedules associated with traffic pattern configurations corresponding to the processing of the client data, or a time period associated with the processing of the client data.

In some implementations of the network entity, the processor, and the method described herein, the HTTP request includes a GET command, where the non-custom operation is based on the HTTP request being the GET command, and where the non-custom operation is associated with a filter criterion for the processing of the client data. In some implementations of the network entity, the processor, and the method described herein, the filter criterion corresponds to one or more of a type of the client data, a client data preparation criterion, a client data analysis criterion, one or more schedules associated with traffic pattern configurations corresponding to the processing of the client data, or a time period associated with the processing of the client data. In some implementations of the network entity, the processor, and the method described herein, the network entity includes an AIMLE server, and where the network entity, the processor, and the method may further be configured to, capable of, or operable to transmit the HTTP request to an AIMLE client.

A device (e.g., an AIMLE client) for wireless communication is described. The device may be configured to, capable of, or operable to perform one or more operations as described herein. For example, the device may be configured to, capable of, or operable to receive an HTTP request that triggers processing of client data, where the HTTP request indicates a custom operation triggering the processing of the client data or a non-custom operation triggering the processing of the client data, process, based on the custom operation or the non-custom operation, the client data, and transmit a response to the HTTP request that indicates an outcome of the processing of the client data.

A processor (e.g., a standalone processor chipset, or a component of a device) for wireless communication is described. The processor may be configured to, capable of, or operable to perform one or more operations as described herein. For example, the processor may be configured to, capable of, or operable to receive an HTTP request that triggers processing of client data, where the HTTP request indicates a custom operation triggering the processing of the client data or a non-custom operation triggering the processing of the client data, process, based on the custom operation or the non-custom operation, the client data, and transmit a response to the HTTP request that indicates an outcome of the processing of the client data.

A method performed or performable by a device for wireless communication is described. The method may include receiving an HTTP request that triggers processing of client data, where the HTTP request indicates a custom operation triggering the processing of the client data or a non-custom operation triggering the processing of the client data, processing, based on the custom operation or the non-custom operation, the client data, and transmitting a response to the HTTP request that indicates an outcome of the processing of the client data.

In some implementations of the device, the processor, and the method described herein, the device, the processor, and the method may further be configured to, capable of, or operable to at least one of prepare the client data (client data cleaning, client data transformation, client data normalization, client data aggregation, client data filtering, client data formatting, etc.) or analyze the client data (statistical analysis, outlier detection, anomaly identification, feature correlation analysis, traffic pattern analysis, performance metrics evaluation, trend analysis, machine learning inference, etc.), where the HTTP request indicates for the processing of the client data to include at least one of preparation of the client data or analysis of the client data. In some implementations of the device, the processor, and the method described herein, the response to the HTTP request indicates one or more of that the processing of the client data is successful, that the processing of the client data has failed and a corresponding error code, a notification that the processing of the client data is redirected to an additional device, processed client data, or a timestamp associated with the processing of the client data. In some implementations of the device, the processor, and the method described herein, the HTTP request includes a POST command, and where the custom operation is based on the HTTP request being the POST command. In some implementations of the device, the processor, and the method described herein, the POST command indicates one or more of a type of the client data, a client data preparation criterion, a client data analysis criterion, one or more schedules associated with traffic pattern configurations corresponding to the processing of the client data, or a time period associated with the processing of the client data.

In some implementations of the device, the processor, and the method described herein, the HTTP request includes a GET command, where the non-custom operation is based on the HTTP request being the GET command, and where the non-custom operation is associated with a filter criterion for the processing of the client data. In some implementations of the device, the processor, and the method described herein, the filter criterion corresponds to one or more of a type of the client data, a client data preparation criterion, a client data analysis criterion, one or more schedules associated with traffic pattern configurations corresponding to the processing of the client data, or a time period associated with the processing of the client data. In some implementations of the device, the processor, and the method described herein, the device, the processor, and the method may further be configured to, capable of, or operable to determine, based on an identity associated with a network entity, that the network entity is authorized for the HTTP request. In some implementations of the device, the processor, and the method described herein, the device, the processor, and the method may further be configured to, capable of, or operable to receive the HTTP request from an AIMLE server, and where the device includes an AIMLE client.

### BRIEF DESCRIPTION OF THE DRAWINGS

FIG. 1 illustrates an example of a wireless communications system in accordance with aspects of the present disclosure.

FIGS. 2 and 3 illustrate examples of signaling diagrams, in accordance with aspects of the present disclosure.

FIG. 4 illustrates an example of an application programing interface (API) architecture diagram, in accordance with aspects of the present disclosure.

FIG. 5 illustrates an example of a device in accordance with aspects of the present disclosure.

FIG. 6 illustrates an example of a processor in accordance with aspects of the present disclosure.

FIG. 7 illustrates an example of a network entity in accordance with aspects of the present disclosure.

FIG. 8 illustrates a flowchart of a method performed by a device in accordance with aspects of the present disclosure.

FIG. 9 illustrates a flowchart of a method performed by an network entity in accordance with aspects of the present disclosure.

### DETAILED DESCRIPTION

A wireless communications system can include one or more entities and devices to implement various services. For example, a wireless communications system can include an AIMLE server and an AIMLE client to implement a data management service. A data management service may facilitate the collection, processing, and/or analysis of AIMLE data (e.g., network performance data, traffic flow pattern data, resource utilization data, machine learning model training datasets, artificial intelligence inference results) via messaging between an AIMLE server and an AIMLE client. In some cases, the AIMLE server may send a request to an AIMLE client that triggers data processing operations at the AIMLE client. The AIMLE client may send the results of the data processing operations to the AIMLE server using a standard communication protocol. The AIMLE server forwards the results of the data processing operations to an AIMLE service consumer. However, the AIMLE server may send a standard request to the AIMLE client to trigger processing of the data, regardless of the use case or requested processing for the data. Utilizing a standard request may result in inefficient data processing for different types of data processing operations. For example, using a standard request may not provide for specifying different processing parameters or filtering criterion, resulting in unnecessary computational overhead and bandwidth utilization in the wireless communications system. Additionally, or alternatively, the standard request may not provide sufficient flexibility to accommodate various client data processing tasks, such as data preparation and/or data analysis.

As described herein, to reduce unnecessary computational overhead and bandwidth utilization related to standard requests for client data processing, a network entity (e.g., an AIMLE server) can send an HTTP request to a device (e.g., an AIMLE client) that indicates a custom operation or a non-custom operation for triggering processing of client data. For example, the network entity sends an HTTP request that includes a command to the device. The command may be a POST command that indicates the network entity is triggering client data processing with defined preparation or analysis parameters. Additionally, or alternatively, the command may be a GET command that indicates the network entity is triggering client data processing using filter criterion related to defined data types, preparation criterion, analysis criterion, traffic pattern configurations, or time periods. The device processes the request and performs the client data processing utilizing the defined preparation or analysis parameters and/or the filter criterion. The device transmits a response indicating the outcome of the processing to the network entity. The response may indicate that the processing was successful, indicate that the processing failed with an error code, indicate that the processing was redirected to another device, include processed client data, or provide a timestamp of the processing.

By performing the described techniques, one or more devices and/or network entities in a wireless communications system (e.g., an AIMLE server and/or an AIMLE client) can efficiently implement client data processing, reducing computational overhead and bandwidth utilization related to standard client data processing requests. Enabling the network entity to use different HTTP commands (e.g., POST and GET) to trigger client data processing at a device provides for network entities to either customize the data processing with defined preparation or analysis parameters or filter criterion according to use cases and capabilities of the device. Using the different HTTP commands may lead to improved resource allocation, enhanced data processing efficiency, and improved adaptability of various devices (e.g., AIMLE clients) and the network entity to different network conditions and data processing tasks (use cases, criterion, etc.).

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

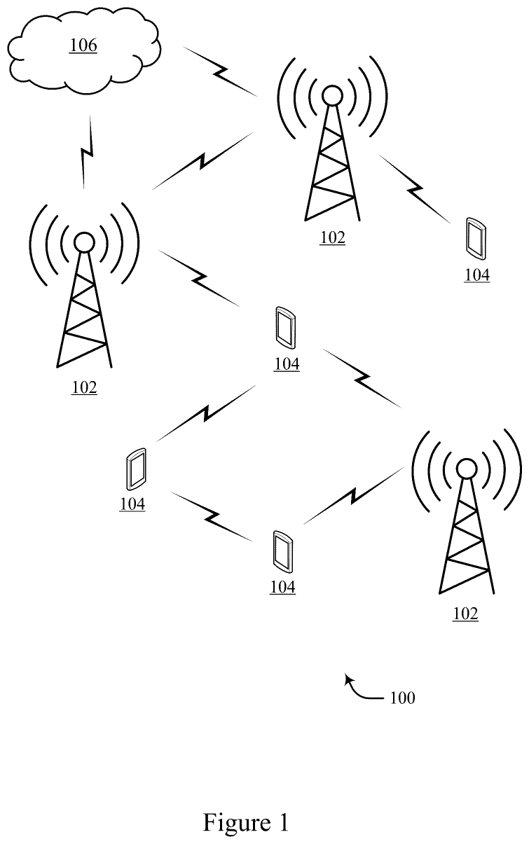

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity may be configured in a disaggregated architecture, which may be configured to utilize a protocol stack physically or logically distributed among two or more network entities, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities in a disaggregated RAN architecture may be co-located, or one or more components of the network entities may be located in distributed locations (e.g., separate physical locations). In some implementations, one or more network entities of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack, and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaptation protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack, and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ0, μ1, μ2, μ3, μ4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ1), which includes 30 kHz subcarrier spacing; and a third numerology (e.g., μ2), which includes 60 kHz subcarrier spacing. FR2 may be associated with one or multiple numerologies (e.g., at least 2 numerologies). For example, FR2 may be associated with a third numerology (e.g., μ2), which includes 60 kHz subcarrier spacing; and a fourth numerology (e.g., μ3), which includes 120 kHz subcarrier spacing.

The wireless communications system 100 may include a network entity, such as an AIMLE server, and a device, such as an AIMLE client, to implement a data management service. A data management service may facilitate the collection, processing, and analysis of client data via messaging between an AIMLE server and an AIMLE client. In some cases, the data management service may handle various types of client data, such as AIMLE data, which may include network performance data, traffic flow pattern data, resource utilization data, machine learning model training datasets, and artificial intelligence inference results. The data management service may perform one or more procedures or operations, such as data preparation operations (client data cleaning, client data transformation, client data normalization, client data aggregation, client data filtering, client data formatting, etc.) and data analysis operations (statistical analysis, outlier detection, anomaly identification, feature correlation analysis, traffic pattern analysis, performance metrics evaluation, trend analysis, machine learning inference, etc.). In some cases, the data management service may utilize dataset identifiers to organize and manage different collections of application data, and may support both numerical and categorical data formats for processing operations.

The AIMLE server may be an example of a network entity (e.g., a CN 106, or implemented by a CN 106) that coordinates and manages data processing operations for the data management service. In some cases, the AIMLE server may receive requests from AIMLE service consumers (e.g., vertical application layer (VAL) servers, among other example service consumers) for data management assistance, authenticate and authorize the requests, and assign subscription identifiers for tracking the data management assistance. The AIMLE server may send client data processing requests to AIMLE clients to trigger client data processing at the AIMLE clients. Additionally, or alternatively, the AIMLE server may aggregate outputs received from multiple AIMLE clients, performing statistical operations or combining data accordingly. In some cases, the AIMLE server may support operational scheduling for data management operations and may provide notifications to AIMLE service consumers regarding the completion and results of the data processing.

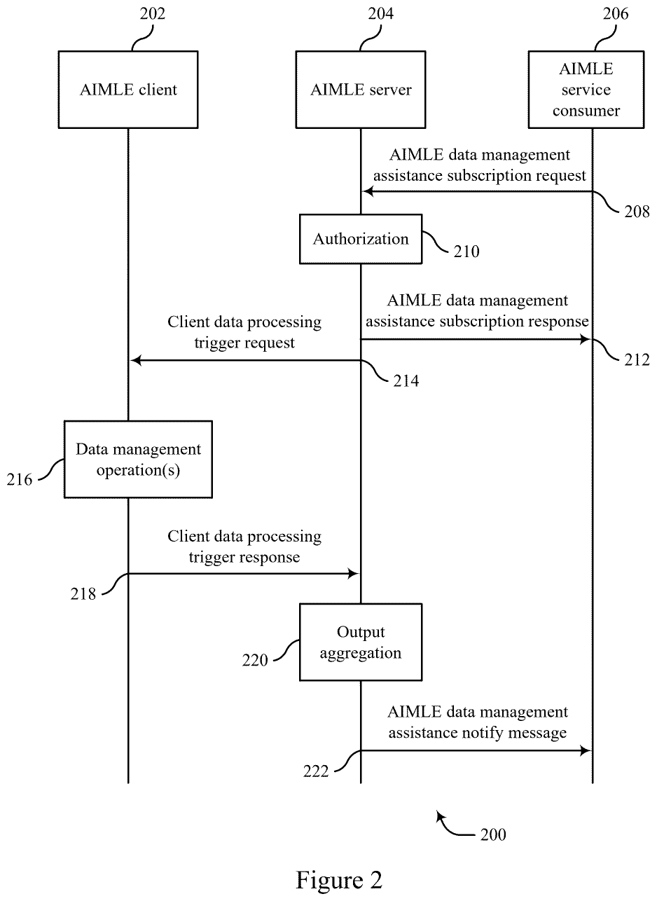

The AIMLE client may be an example of a device (e.g., NE 102, UE 104, network device, network entity, server device, or any other device) that performs the data processing requested by the AIMLE server. In some cases, the AIMLE client may receive client data processing trigger requests and may execute data preparation or data analysis operations on local application data. The AIMLE client may verify the identity and authorization of requesting AIMLE servers before processing requests. In some cases, the AIMLE client may support various data preparation operations, such as dataset feature processing and data transformation, as well as data analysis functions, including statistical computations and anomaly detection. The AIMLE client may generate outputs in response to processing requests, providing results that may include prepared data, analysis results, and timestamps of the processing operations. Additionally, or alternatively, the AIMLE client may support redirection capabilities to forward requests to alternative AIMLE clients, which is described in further detail with respect to FIG. 2.

In some cases, a data management service implementation may utilize standard client data processing trigger requests that lack flexibility and customization capabilities for different types of data processing operations. For example, a standard trigger request may not provide for an AIMLE server to indicate data processing criterion or parameters, such as dataset feature processing criterion, data cleaning parameters, statistical analysis parameters, or anomaly detection thresholds, among other examples, leading to unnecessary computational overhead when processing datasets. In some examples, standard trigger requests may not accommodate different operational schedules or traffic pattern configurations, leading to inefficient resource utilization across multiple AIMLE clients. Further, the lack of customization in standard requests may prevent AIMLE servers from efficiently coordinating data processing operations across diverse client capabilities, resulting in increased bandwidth utilization and processing delays in the wireless communications system 100.

According to implementations, one or more of the devices and/or network entities are operable to implement various aspects of the techniques described with reference to the present disclosure. For example, a network entity, such as an AIMLE server, may transmit an HTTP request associated with client data to a device, such as an AIMLE client. The HTTP request may indicate a custom operation for triggering processing of the client data or a non-custom operation for triggering the processing of the client data. The custom operation may be based on the HTTP request being a POST command that indicates the network entity is triggering client data processing with defined preparation or analysis parameters. The non-custom operation may be based on the HTTP request being a GET command that indicates the network entity is triggering client data processing using filter criterion related to defined data types, preparation criterion, analysis criterion, traffic pattern configurations, or time periods. The network entity receives a response to the HTTP request that indicates an outcome of the processing of the client data. The device processes the client data based on the custom operation or the non-custom operation and transmits the response indicating the outcome of the processing, which may include an indication of success, failure with an error code, redirection to another device, processed client data, or a timestamp of the processing.

A network entity may be any device, component, or system that participates in network communications and operations within the wireless communications system 100. Network entities may include hardware devices, software applications, virtualized functions, or combinations thereof that are capable of transmitting, receiving, processing, or managing data within the network infrastructure. In some cases, network entities may perform various roles in facilitating client data processing services and related operations. For example, a network entity may function as an AIMLE server, which may request and trigger client data processing operations at AIMLE clients for data preparation or data analysis. The AIMLE server may transmit HTTP requests to trigger client data processing and may process the received responses to implement data management services or aggregate outputs from multiple AIMLE clients. Additionally, or alternatively, a network entity may serve as an AIMLE service consumer, which may request data management assistance from an AIMLE server and utilize the processed client data for various applications. The network entities may communicate with each other through various interfaces and protocols to enable efficient client data processing across the wireless communications system 100.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of a signaling diagram 200 in accordance with aspects of the present disclosure. In some examples, the signaling diagram 200 implements or is implemented by aspects of the wireless communications system 100. The signaling diagram 200 may implement or be implemented by one or more devices and/or entities (e.g., UEs, NEs, network entities, or other devices or entities), including an AIMLE client 202, an AIMLE server 204, and an AIMLE service consumer 206, which may be examples of or may be implemented by a CN 106, NEs 102, UEs 104, and/or other devices or entities, as described with reference to FIG. 1. For example, the signaling diagram 200 may illustrate an example of AIMLE data management assistance for client data processing. Alternative examples of the following may be implemented, where some processes are performed in a different order than described or are not performed. In some cases, processes may include additional features not mentioned below, or further processes may be added.

The AIMLE service consumer 206 may initiate data management assistance requests for various vertical applications and analytical use cases (e.g., purposes, tasks, operations, functions). The AIMLE service consumer 206 may include or may be implemented by one or more network entities, such as a VAL server, application function (AF), network exposure function (NEF), or other network entities. The AIMLE service consumer 206 may implement AIMLE data management assistance to obtain aggregated and analyzed data from distributed AIMLE clients, enabling applications to make informed decisions utilizing network performance metrics, traffic patterns, resource utilization statistics, or machine learning inference results. In some cases, the AIMLE service consumer 206 may utilize the processed data for improving network operation, predictive analytics, anomaly detection, or service quality assessments across a wireless communications system.

The AIMLE server 204 may coordinate and manage client data processing operations between AIMLE service consumers and AIMLE clients for the data management service. For example, the AIMLE server 204 may receive subscription requests from the AIMLE service consumer 206, perform authentication and authorization procedures, and assign subscription identifiers for tracking data management assistance operations. The AIMLE client 202 may be a data processing entity that executes client data processing operations in response to trigger requests from the AIMLE server 204.

At 208, the AIMLE service consumer 206 sends an AIMLE data management assistance subscription request to the AIMLE server 204. The request includes information, such as a requestor identifier, data management operations (e.g., data preparation or data analysis), data management criterion (e.g., requirements), and optionally an AIMLE clients list or selection criterion.

At 210, the AIMLE server 204 performs authentication and authorization of the request. If authorized, then the AIMLE server 204 assigns an identifier for the subscription to track the data management assistance.

At 212, the AIMLE server 204 sends an AIMLE data management assistance subscription response to the AIMLE service consumer 206. The response includes the status of the request, a subscription identifier, and optionally an expiration time for the subscription.

At 214, the AIMLE server 204 sends a client data processing trigger request to the AIMLE client 202. The request can be for data preparation or data analysis and includes information, such as the requestor identifier, data management type, data management criterion (e.g., requirements), and optionally an operational schedule.

At 216, the AIMLE client 202 performs the requested data management operations locally. In some cases, the AIMLE layer transports the functions to the client, and the client performs the associated function on the application data.

At 218, after completing the data operations, the AIMLE client 202 sends a client data processing trigger response to the AIMLE server 204. The response includes a status of the operation, data preparation outputs, data analysis outputs (e.g., numerical or categorical), and/or optionally a timestamp of the operation.

At 220, the AIMLE server 204 aggregates the outputs received from the AIMLE client 202 and optionally one or more other AIMLE clients if multiple clients are involved. Aggregation includes combining or performing statistical operations on the received data. In some cases, the AIMLE server 204 and the AIMLE client 202 may repeat 214 through 220 to complete data operations.

At 222, the AIMLE server 204 sends an AIMLE data management assistance notification message to the AIMLE service consumer 206. The notification message includes a status of the operation, aggregated data preparation outputs, aggregated data analysis outputs, and/or optionally a timestamp of the notification.

The AIMLE server 204 may trigger the AIMLE client 202 to perform client data processing procedure according to a criterion for the data preparation or the data analysis. Upon completion of the procedure for the client data processing, the AIMLE client 202 provides the AIMLE server 204 output for either the data preparation or the data analysis, which the AIMLE server 204 after some internal treatment, forwards that output towards an AIMLE service consumer 206. However, the AIMLE server 204 may implement a standard protocol for triggering the AIMLE client 202 to perform the client data processing, which may not provide sufficient flexibility for customizing data processing operations according to one or more defined use cases or client capabilities.

FIG. 3 illustrates an example of a signaling diagram 300 in accordance with aspects of the present disclosure. In some examples, the signaling diagram 300 implements or is implemented by aspects of the wireless communications system 100 and the signaling diagram 200. The signaling diagram 300 may implement or be implemented by devices and/or entities (e.g., UEs, NEs, network entities, or other devices or entities), including an AIMLE client 302 and an AIMLE server 304, which may be examples of the AIMLE client 202 and the AIMLE server 204, as described with reference to FIG. 2. The signaling diagram 300 may illustrate an example of a data management service for processing of client data using HTTP requests with different operations. Alternative examples of the following may be implemented, where some processes are performed in a different order than described or are not performed. In some cases, processes may include additional features not mentioned below, or further processes may be added.

At 306, the AIMLE server 304 transmits an HTTP request to trigger processing of client data to the AIMLE client 302. The HTTP request may indicate an operation for the processing. The operation may include a custom operation, such as a POST command, or a non-custom operation, such as a GET command. If the HTTP request includes a POST command, then the operation is a custom operation that enables the AIMLE server 304 to trigger client data processing with defined preparation or analysis parameters. The POST command may indicate one or more of a type of the client data, a client data preparation criterion, a client data analysis criterion, one or more schedules for traffic pattern configurations corresponding to the processing of the client data, or a time period for the processing of the client data.

If the HTTP request includes a GET command, then the operation is a non-custom operation, and the client data processing is triggered using filter criterion for the processing of the client data. The filter criterion may correspond to one or more of a type of the client data, a client data preparation criterion, a client data analysis criterion, one or more schedules for traffic pattern configurations corresponding to the processing of the client data, or a time period for the processing of the client data. In some examples, the AIMLE client 302 may be configured (e.g., preconfigured) with the filter criterion. In some other examples, the AIMLE client 302 may determine the filter criterion using processing parameters included in the HTTP request. For example, the AIMLE client 302 may use the parameters to identify and select relevant client data processing operations that match the parameters, such as dataset identifiers, feature processing criterion (e.g., requirements), statistical analysis functions, or anomaly detection thresholds.

At 308, the AIMLE client 302 processes the client data based on the custom operation or non-custom operation indicated in the HTTP request. For custom operations, the AIMLE client 302 may verify the identity of the requesting AIMLE server 304 and determine authorization to perform the client data processing. The AIMLE client 302 may perform data preparation operations (e.g., client data cleaning, client data transformation, client data normalization, client data aggregation, client data filtering, client data formatting) or data analysis operations (e.g., statistical analysis, outlier detection, anomaly identification, feature correlation analysis, traffic pattern analysis, performance metrics evaluation, trend analysis, machine learning inference) according to the defined parameters. For non-custom operations, the AIMLE client 302 may apply the filter criterion to select and process relevant client data according to the defined parameters.

At 310, the AIMLE client 302 transmits a response to the HTTP request to the AIMLE server 304. The response indicates an outcome of the processing of the client data. The response may indicate one or more of that the processing of the client data is successful, that the processing of the client data has failed and a corresponding error code, a notification that the processing of the client data is redirected to an additional device, processed client data, or a timestamp associated with the processing of the client data. For example, the response may include prepared data outputs, such as cleaned datasets, transformed feature vectors, or normalized data structures, and/or analysis outputs (e.g., statistical summaries, detected anomalies, correlation matrices, or machine learning inference results) to enable the AIMLE server 304 to aggregate the processed data with outputs from other AIMLE clients or forward the results to an AIMLE service consumer.

A data management service, referred to as an Aimlec_ClientDataProcessing service operation, enables the communication between the AIMLE server 304 and the AIMLE client 302 for triggering the client data processing, as described with reference to FIG. 2. The client data processing is provided by the AIMLE client 302, and the AIMLE server 304 may use an API (e.g., an Aimlec_ClientDataProcessing API) to trigger the client data processing. The service operation defined for the Aimlec_ClientDataProcessing API is shown in Table 1.

TABLE 1
Operations for Aimlec_ClientDataProcessing service

| Service operation name | Description | Initiated by |
|---|---|---|
| Aimlec_ClientDataProcessing_Request | The service operation is used by the | AIMLE server |
| | AIMLE server 304 to send | 304 |
| | information to the AIMLE client to | |
| | trigger the client data processing. | |

The Aimlec_ClientDataProcessing_Request service operation is used by the AIMLE server 304 to trigger the client data processing procedure at the AIMLE client 302, which includes the data preparation or the data analysis. In some examples, the AIMLE server 304 implements custom operations for the data management service. For example, to trigger the AIMLE client 302 for the client data processing, the AIMLE server 304 may send an HTTP POST request (e.g., a custom operation, including “Trigger client data processing”) with a request uniform resource identifier (URI) set to “{apiRoot}/aimlec-data-proc/<apiVersion>/trigger,” and with a body including a defined structure data type, CltDataProcReq.

Upon receipt of the HTTP POST request from the AIMLE server 304, the AIMLE client 302 may verify the identity of the AIMLE server 304 and determine if the AIMLE server 304 is authorized for the request. If the AIMLE server 304 is not authorized to trigger the client data processing, then the AIMLE client 302 may respond to the AIMLE server 304 with a corresponding error status code. If the AIMLE server 304 is authorized to subscribe to trigger the client data processing and if the received request is handled locally, then the AIMLE client 302 may perform the client data processing. If the AIMLE client 302 has performed the client data processing, then in the response, the AIMLE client 302 may include an indication of success and may include a defined CltDataProcResp structure data type. If the AIMLE client 302 has not performed the client data processing, then in the response, the AIMLE client 302 may include an indication of failure and may include a corresponding error response. If the AIMLE client 302 has redirected the client data processing, then the AIMLE client 302 may respond with an HTTP “307 Temporary Redirect” status code or an HTTP “308 Permanent Redirect” status code including an HTTP “Location” header including an alternative URI representing the end point of an alternative AIMLE client towards which the request may be sent.

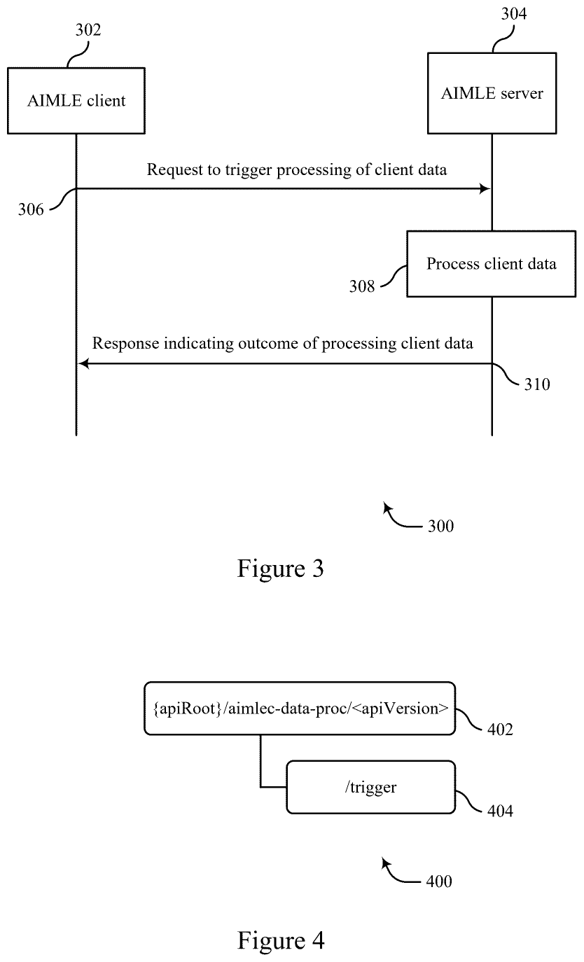

The client data processing service may use the Aimlec_ClientDataProcessing API. The API URI of the Aimlec_ClientDataProcessing API may be {apiRoot}/<apiName>/<apiVersion>, as described in further detail with respect to FIG. 4. The request URIs used in HTTP requests may have a defined resource URI structure. For example, the resource URI structure for the request URIs in the HTTP request may be {apiRoot}/<apiName>/<apiVersion>/<apiSpecificSuffixes>, with one or more components. The components may include, but are not limited to, a defined {apiRoot}, an <apiName>, which may be “aimlec-data-proc,” an<apiVersion>, which may be “v1,” and/or one or more defined <apiSpecificSuffixes>. Table 2 provides an overview of the custom operations and applicable HTTP methods defined for the Aimlec_ClientDataProcessing API.

TABLE 2
Custom operations without associated resources

| | Custom operation | Mapped HTTP | |
|---|---|---|---|
| Operation name | URI | method | Description |
| Trigger client data | /trigger | POST | Used by the AIMLE server 304 to |
| processing | | | trigger the AIMLE client 302 for the |
| | | | client data processing. |

The custom operation enables the AIMLE server 304 to trigger the AIMLE client 302 for the client data processing, which includes the data preparation or the data analysis. The custom operation may support the response data structures and response codes specified in Tables 3, 4, and 5. In some cases, P may indicate a presence, including M for mandatory, C for conditional, and O for optional. Cardinality refers to a number (e.g., amount, numerical quantity) of elements or occurrences for a parameter or field. The cardinality column in the tables provides information that indicates how many instances of an item are present, including 1 for one instance, 0 . . . 1 for zero or one instance (e.g., optional, but no more than one), 0 . . . N or 0 . . . : for zero to many instances (e.g., any number, including none), 1 . . . N or 1 . . . : for one to many instances (e.g., at least one, but can be more), and M . . . N for a defined range, where M is the minimum and N is the maximum number of instances.

TABLE 3
Data structures supported by the POST request body on the resource

| Data type | P | Cardinality | Description |
|---|---|---|---|
| CltDataProcReq | M | 1 | Information used to trigger the client data processing. |

TABLE 4
Data structures supported by the POST response body on the resource

| Data type | Response codes | Description |
|---|---|---|
| CltDataProcResp | 200 OK | Successful case. The requested client data processing is |
| | | successfully received and processed, and the processed |
| | | data and optionally a timestamp may be returned in the |
| | | response body. |
| N/A | 204 No Content | Successful case. The requested client data processing is |
| | | successfully received and processed, and no content may |
| | | be returned in the response body. |
| N/A | 307 Temporary | Temporary redirection. The response may include a |
| | redirect | location header field including an alternative URI of the |
| | | resource located in an alternative AIMLE client. |
| | | Redirection handling is configured and/or defined. |
| N/A | 308 Permanent | Permanent redirection. The response may include a |
| | redirect | location header field including an alternative URI of the |
| | | resource located in an alternative AIMLE client. |
| | | Redirection handling is configured and/or defined. |

NOTE:
One or more defined mandatory HTTP error status codes for the HTTP POST method also apply.

TABLE 5
Headers supported by the 307 response code
and the 308 response code on the resource

| Name | Data type | P | Cardinality | Description |
|---|---|---|---|---|
| Location | string | M | 1 | Includes an alternative target |
| | | | | URI located in an alternative |
| | | | | AIMLE client. |

In some cases, the Aimlec_ClientDataProcessing API may support an application data model. For example, Table 6 specifies the data types defined for the Aimlec_ClientDataProcessing API.

TABLE 6
Aimlec_ClientDataProcessing API specific data types

| Data type | Description |
|---|---|
| CltDataProcReq | Represents triggering information for client data |
| | processing. |
| CltDataProcResp | Represents the outcome of the successful client |
| | data processing. |

Table 7 specifies one or more data types reused by the Aimlec_ClientDataProcessing API from other operations and/or services, including a description of use of the data types within the Aimlec_ClientDataProcessing API.

TABLE 7
Aimlec_ClientDataProcessing API reused data types

| Data type | Comments |
|---|---|
| DataMgmtOp | Represents a type of the client data processing. |
| DataPrepReqs | Represents a data preparation criterion (e.g., requirement). |
| DataAnalysisReqs | Represents a data analysis criterion (e.g., requirement). |
| ScheduledCommunicationTime | Used to define schedules for traffic pattern configurations. |
| DateTime | Used to represent the date and time. |

The AIMLE server 304 and the AIMLE client 302 may use one or more structures in resource representations. For example, a CltDataProcReq type of structure is specified in Table 8.

TABLE 8
Definition of type CltDataProcReq

| Attribute name | Data type | P | Cardinality | Description |
|---|---|---|---|---|
| dataProc | DataMgmtOp | M | 1 | Identifies a type of the |
| | | | | client data processing |
| | | | | (e.g., data preparation or |
| | | | | data analysis). |
| dataPrepReq | DataPrepReqs | C | 0 . . . N | Identifies data preparation |
| | | | | criterion for client data |
| | | | | processing. (NOTE) |
| dataAnalysisReq | DataAnalysisReqs | C | 0 . . . N | Identifies data analysis |
| | | | | criterion for client data |
| | | | | processing. (NOTE) |
| dataProcSched | ScheduledCommunicationTime | O | 0 . . . 1 | Identifies a schedule for |
| | | | | client data processing. |

NOTE:
At least one of the attributes dataPrepReq or dataAnalysisReq may be present.

In some cases, a CltDataProcResp type of structure is specified in Table 9.

TABLE 9
Definition of type CltDataProcResp

| Attribute name | Data type | P | Cardinality | Description |
|---|---|---|---|---|
| dataPrepOutputs | Configured | C | 0 . . . N | Identifies one or more outputs for the client |
| | or defined | | | data processing, where each output is with |
| | | | | respect to a data preparation criterion. |
| | | | | (NOTE) |
| dataAnalysisOutputs | Configured | C | 0 . . . N | Identifies one or more outputs for the client |
| | or defined | | | data processing, where each output is with |
| | | | | respect to a data analysis criterion. (NOTE) |
| timeStamp | DateTime | O | 0 . . . 1 | Identifies the timestamp for the client data |
| | | | | processing. |

NOTE:
At least one of the attributes dataPrepOutputs or dataAnalysisOutput may be present.

For the Aimlec_ClientDataProcessing API, one or more defined HTTP error responses may be supported. For example, the AIMLE server 304 and the AIMLE client 302 may support one or more protocol errors and application errors for various different HTTP status codes. Additionally, or alternatively, the AIMLE server 304 and the AIMLE client 302 may implement one or more defined security provisions for the Aimlec_ClientDataProcessing API.

In some examples, the AIMLE server 304 implements non-custom operations for the data management service. For example, the non-custom operations for the data management service enables communication between the AIMLE server 304 and the AIMLE client 302 for triggering the client data processing by using filter criterion. The client data processing is provided by the AIMLE client 302.

The AIMLE server 304 and the AIMLE client 302 may implement a service operation, Aimlec_ClientDataProcessing, for the non-custom operation. For example, the AIMLE server 304 may implement an API for the Aimlec_ClientDataProcessing, referred to as an Aimlec_ClientDataProcessing API. Operations for the Aimlec_ClientDataProcessing service are shown in the Table 10.

TABLE 10
Operations for Aimlec_ClientDataProcessing service

| Service operation name | Description | Initiated by |
|---|---|---|
| Aimlec_ClientDataProcessing_Request | The service operation is used by | AIMLE server 304 |
| | the AIMLE server 304 to send | |
| | information to the AIMLE client | |
| | 302 to trigger the client data | |
| | processing. | |

The Aimlec_ClientDataProcessing_Request service operation is used by the AIMLE server 304 to trigger the AIMLE client 302 for the client data processing procedure, which includes the data preparation or the data analysis. To trigger the AIMLE client 302 for the client data processing, the AIMLE server 304 may send an HTTP GET request. Upon receipt of the HTTP GET request from the AIMLE server 304, the AIMLE client 302 may verify the identity of the AIMLE server 304 and determine if the AIMLE server 304 is authorized for the request. If the AIMLE server 304 is not authorized to trigger the client data processing, then the AIMLE client 302 may respond to the AIMLE server 304 with a corresponding error status code. If the AIMLE server 304 is authorized to subscribe to trigger the client data processing and if the received request is handled locally, then the AIMLE client 302 may perform the client data processing. If the AIMLE client 302 has performed the client data processing, then in the response, the AIMLE client 302 may include an indication of success and may include a defined CltDataProcResp structure data type. If the AIMLE client 302 has not performed the client data processing, then in the response, the AIMLE client 302 may include an indication of failure and may include a corresponding error response. If the AIMLE client 302 redirects the client data processing, then the AIMLE client 302 may respond with an HTTP “307 Temporary Redirect” status code or an HTTP “308 Permanent Redirect” status code including an HTTP “Location” header including an alternative URI representing the end point of an alternative AIMLE client towards which the request may be sent. The redirection handling is defined or configured at the AIMLE client 302.

The client data processing service for the non-custom operation may use the Aimlec_ClientDataProcessing API. The API URI of the Aimlec_ClientDataProcessing API may be {apiRoot}/<apiName>/<apiVersion>, and the request URIs used in HTTP requests may have a defined resource URI structure, {apiRoot}/<apiName>/<apiVersion>/<apiSpecificSuffixes>, which is described in further detail with respect to FIG. 4. The URI structure may include, but is not limited to, a defined {apiRoot}, an<apiName>, which may be “aimlec-data-proc,” an <apiVersion>, which may be “v1,” and/or one or more defined <apiSpecificSuffixes>.

The AIMLE server 304 and/or the AIMLE client 302 may implement one or more resources and HTTP methods for the non-custom operation for the client data processing service. Table 11 provides an overview of the resources and applicable HTTP methods.

TABLE 11
Resources and methods overview

| | | HTTP method | |
|---|---|---|---|
| Resource name | Resource URI | or operation | Description |
| Trigger client | /trigger | GET | The AIMLE server 304 triggers |
| data processing | | | the AIMLE client 302 for client |
| | | | data processing. |

The trigger client data processing resource enables the AIMLE server 304 to trigger the AIMLE client 302 for the client data processing, which includes the data preparation or the data analysis. A resource URI, {apiRoot}/aimlec-data-proc/<apiVersion>/trigger, may support one or more resource URI variables defined in Table 12.

TABLE 12
Resource URI variables for this resource

| | Data | |
|---|---|---|
| Name | type | Definition |
| apiRoot | string | Represents a sequence of zero or more Unicode |
| | | characters encoded using UTF-8. Used to represent |
| | | text-based information in API requests and responses. |

The GET command may support the URI query parameters specified in Table 13.

TABLE 13
URI query parameters supported by the GET command on the resource

| Name | Data type | P | Cardinality | Description | Applicability |
|---|---|---|---|---|---|
| filt-criteria | CltDataProcReq | M | 1 | Represents the client data | filt-criteria |
| | | | | processing filtering criterion. | |

The GET command may support the response data structures and response codes specified in Tables 14 and 15.

TABLE 14
Data structures supported by the GET response body on the resource

| Data type | Response codes | Description |
|---|---|---|
| CltDataProcResp | 200 OK | Successful case. The requested client data processing is |
| | | successfully received and processed, and the processed |
| | | data and optionally a timestamp may be returned in the |
| | | response body. |
| N/A | 204 No content | Successful case. The requested client data processing is |
| | | successfully received and processed, and no content may |
| | | be returned in the response body. |
| N/A | 307 Temporary | Temporary redirection. The response may include a |
| | redirect | location header field including an alternative URI of the |
| | | resource located in an alternative AIMLE client. |
| | | Redirection handling is configured and/or defined. |
| N/A | 308 Permanent | Permanent redirection. The response may include a |
| | redirect | location header field including an alternative URI of the |
| | | resource located in an alternative AIMLE client. |
| | | Redirection handling is configured and/or defined. |

NOTE:
One or more defined mandatory HTTP error status codes for the HTTP POST method also apply.

TABLE 15
Headers supported by the 307 response code
and the 308 response code on the resource

| Name | Data type | P | Cardinality | Description |
|---|---|---|---|---|
| Location | string | M | 1 | Includes an alternative target |
| | | | | URI located in an alternative |
| | | | | AIMLE client. |

The Aimlec_ClientDataProcessing API may support an application data model. For example, Table 16 specifies the data types defined for the Aimlec_ClientDataProcessing API.

TABLE 16
Aimlec_ClientDataProcessing API specific data types

| Data type | Description |
|---|---|
| CltDataProcReq | Represents triggering information for client data |
| | processing. |
| CltDataProcResp | Represents an outcome of successful client data |
| | processing. |

Table 17 specifies data types reused by the Aimlec_ClientDataProcessing API from other services or operations, including a description of use within the Aimlec_ClientDataProcessing API.

TABLE 17
Aimlec_ClientDataProcessing API reused data types

| Data type | Comments |
|---|---|
| DataMgmtOp | Represents a type of client data |
| | processing. |
| DataPrepReqs | Represents a data preparation criterion |
| | (e.g., requirement). |
| DataAnalysisReqs | Represents a data analysis criterion |
| | (e.g., requirement). |
| ScheduledCommunicationTime | Used to define schedules for traffic |
| | pattern configurations. |
| DateTime | Used to represent date and time. |

The AIMLE server 304 and/or the AIMLE client 302 may use one or more structures in resource representations. For example, a CltDataProcReq structure type is specified in Table 18.

TABLE 18
Definition of type CltDataProcReq

| Attribute name | Data type | P | Cardinality | Description |
|---|---|---|---|---|
| dataProc | DataMgmtOp | M | 1 | Identifies a type of the |
| | | | | client data processing |
| | | | | (e.g., data preparation or |
| | | | | data analysis). |
| dataPrepReq | DataPrepReqs | C | 0 . . . N | Identifies data preparation |
| | | | | criterion (e.g., |
| | | | | requirements) for the |
| | | | | client data processing. |
| | | | | (NOTE) |
| dataAnalysisReq | DataAnalysisReqs | C | 0 . . . N | Identifies the data analysis |
| | | | | criterion (e.g., |
| | | | | requirements) for the |
| | | | | client data processing. |
| | | | | (NOTE) |
| dataProcSched | ScheduledCommunicationTime | O | 0 . . . 1 | Identifies a schedule for |
| | | | | the client data processing. |

NOTE:
At least one of the attributes dataPrepReq or dataAnalysisReq may be present.

In some cases, a CltDataProcResp structure type is specified in Table 19.

TABLE 19
Definition of type CltDataProcResp

| Attribute name | Data type | P | Cardinality | Description |
|---|---|---|---|---|
| dataPrepOutputs | Configured | C | 0 . . . N | Identifies one or more outputs for client |
| | and/or | | | data processing, where each output is with |
| | defined | | | respect to a data preparation criterion (e.g., |
| | | | | requirement). (NOTE) |
| dataAnalysisOutputs | Configured | C | 0 . . . N | Identifies one or more outputs for client |
| | and/or | | | data processing, where each output is with |
| | defined | | | respect to a data analysis criterion (e.g., |
| | | | | requirement). (NOTE) |
| timeStamp | DateTime | O | 0 . . . 1 | Identifies a timestamp for client data |
| | | | | processing. |

NOTE:
At least one of the attributes dataPrepOutputs or dataAnalysisOutput may be present.

The Aimlec_ClientDataProcessing API may support one or more defined HTTP error responses. Additionally, or alternatively, the Aimlec_ClientDataProcessing API may support one or more defined protocol errors and application errors for various HTTP status codes.

FIG. 4 illustrates an example of an API architecture diagram 400 in accordance with aspects of the present disclosure. In some examples, the API architecture diagram 400 implements or is implemented by aspects of the wireless communications system 100, the signaling diagram 200, and the signaling diagram 300. The API architecture diagram 400 may be utilized by network entities and/or devices (e.g., AIMLE servers, AIMLE clients) to trigger client data processing using one or more HTTP requests. For example, the API architecture diagram 400 may provide a structured interface for AIMLE servers to request and trigger client data processing operations at AIMLE clients. The API architecture diagram 400 includes an API root path 402 and a trigger path 404. The API root path 402 is specified as “{apiRoot}/aimlec-data-proc/” and provides a base URI for accessing the client data processing API. The trigger path 404 is specified as “/trigger” and represents a resource endpoint for triggering client data processing operations within the API structure. The API root path 402 may include one or more components, such as the API root, which may be set according to deployment specifications, an API name “aimlec-data-proc,” and an API version, which may be specified as “v1,” in some cases. The trigger path 404 may be used with different HTTP methods, such as POST for custom operations or GET for non-custom operations, to initiate different types of client data processing according to various parameters or filter criterion.

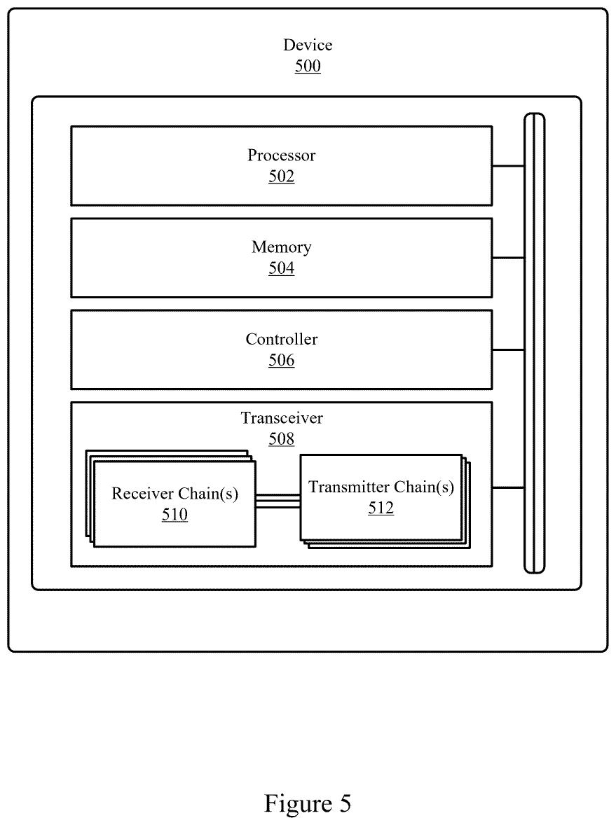

FIG. 5 illustrates an example of a device 500 in accordance with aspects of the present disclosure. The device 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces. The device 500 may be an example of an AIMLE client or any other network device.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field-programmable gate-array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the device 500 to perform various functions of the present disclosure.

The memory 504 may include volatile or non-volatile memory. The memory 504 may store computer-readable, computer-executable code including instructions when executed by the processor 502 cause the device 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the device 500 to perform one or more of the functions described herein (e.g., executing, by the processor 502, instructions stored in the memory 504). For example, the processor 502 may support wireless communication at the device 500 in accordance with examples as disclosed herein. The device 500 may be configured to or operable to support a means for receiving an HTTP request that triggers processing of client data, where the HTTP request indicates a custom operation triggering the processing of the client data or a non-custom operation triggering the processing of the client data, processing, based on the custom operation or the non-custom operation, the client data, and transmitting a response to the HTTP request that indicates an outcome of the processing of the client data.

Additionally, the device 500 may be configured or operable to support any one or combination of processing the client data includes at least one of preparing the client data or analyzing the client data, where the HTTP request indicates for the processing of the client data to include at least one of preparation of the client data or analysis of the client data. Additionally, or alternatively, the device 500 may be configured or operable to support the response to the HTTP request indicates one or more of that the processing of the client data is successful, that the processing of the client data has failed and a corresponding error code, a notification that the processing of the client data is redirected to an additional device, processed client data, or a timestamp associated with the processing of the client data. Additionally, or alternatively, the device 500 may be configured or operable to support the HTTP request includes a POST command, and where the custom operation is based on the HTTP request being the POST command. Additionally, or alternatively, the device 500 may be configured or operable to support the POST command indicates one or more of a type of the client data, a client data preparation criterion, a client data analysis criterion, one or more schedules associated with traffic pattern configurations corresponding to the processing of the client data, or a time period associated with the processing of the client data.

Additionally, or alternatively, the device 500 may be configured or operable to support the HTTP request includes a GET command, where the non-custom operation is based on the HTTP request being the GET command, and where the non-custom operation is associated with a filter criterion for the processing of the client data. Additionally, or alternatively, the device 500 may be configured or operable to support the filter criterion corresponds to one or more of a type of the client data, a client data preparation criterion, a client data analysis criterion, one or more schedules associated with traffic pattern configurations corresponding to the processing of the client data, or a time period associated with the processing of the client data. Additionally, or alternatively, the device 500 may be configured or operable to support determining, based on an identity associated with a network entity, that the network entity is authorized for the HTTP request. Additionally, or alternatively, the device 500 may be configured or operable to support receiving the HTTP request from an AIMLE server, and where the device includes an AIMLE client.

Additionally, or alternatively, the device 500 may support at least one memory (e.g., the memory 504) and at least one processor (e.g., the processor 502) coupled with the at least one memory and configured to cause the device to receive an HTTP request that triggers processing of client data, where the HTTP request indicates a custom operation triggering the processing of the client data or a non-custom operation triggering the processing of the client data, process, based on the custom operation or the non-custom operation, the client data, and transmit a response to the HTTP request that indicates an outcome of the processing of the client data.

Additionally, the device 500 may be configured or operable to support any one or combination of to process the client data includes at least one of to prepare the client data or to analyze the client data, where the HTTP request indicates for the processing of the client data to include at least one of preparation of the client data or analysis of the client data. Additionally, or alternatively, the device 500 may be configured or operable to support the response to the HTTP request indicates one or more of that the processing of the client data is successful, that the processing of the client data has failed and a corresponding error code, a notification that the processing of the client data is redirected to an additional device, processed client data, or a timestamp associated with the processing of the client data. Additionally, or alternatively, the device 500 may be configured or operable to support the HTTP request includes a POST command, and where the custom operation is based on the HTTP request being the POST command. Additionally, or alternatively, the device 500 may be configured or operable to support the POST command indicates one or more of a type of the client data, a client data preparation criterion, a client data analysis criterion, one or more schedules associated with traffic pattern configurations corresponding to the processing of the client data, or a time period associated with the processing of the client data.

Additionally, or alternatively, the device 500 may be configured or operable to support the HTTP request includes a GET command, where the non-custom operation is based on the HTTP request being the GET command, and where the non-custom operation is associated with a filter criterion for the processing of the client data. Additionally, or alternatively, the device 500 may be configured or operable to support the filter criterion corresponds to one or more of a type of the client data, a client data preparation criterion, a client data analysis criterion, one or more schedules associated with traffic pattern configurations corresponding to the processing of the client data, or a time period associated with the processing of the client data. Additionally, or alternatively, the device 500 may be configured or operable to support to determine, based on an identity associated with a network entity, that the network entity is authorized for the HTTP request. Additionally, or alternatively, the device 500 may be configured or operable to support to receive the HTTP request from an AIMLE server, and where the device includes an AIMLE client.

The controller 506 may manage input and output signals for the device 500. The controller 506 may also manage peripherals not integrated into the device 500. In some implementations, the controller 506 may utilize an operating system such as iOS®, ANDROID®, WINDOWS®, or other operating systems. In some implementations, the controller 506 may be implemented as part of the processor 502.

In some implementations, the device 500 may include at least one transceiver 508. In some other implementations, the device 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

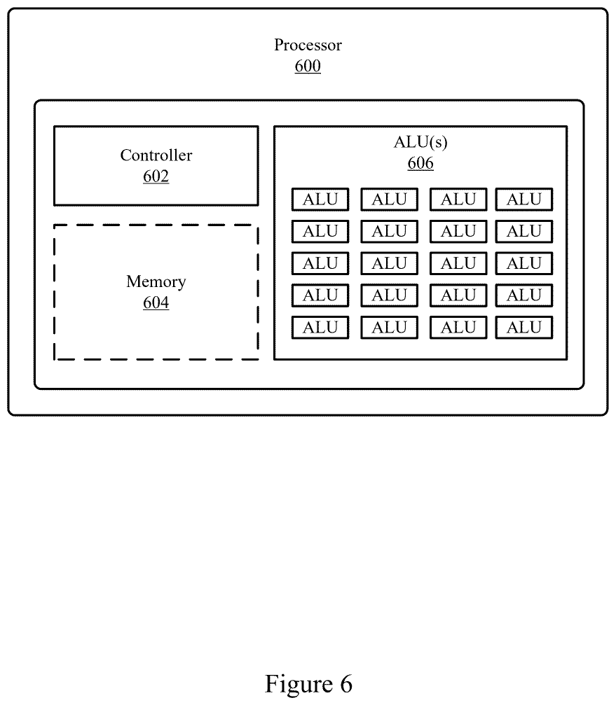

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may be configured to or operable to support at least one controller (e.g., the controller 602) coupled with at least one memory (e.g., the memory 604) and configured to cause the processor to transmit an HTTP request associated with client data, where the HTTP request indicates a custom operation for triggering processing of the client data or a non-custom operation for triggering the processing of the client data, and receive a response to the HTTP request that indicates an outcome of the processing of the client data.

Additionally, the processor 600 may be configured to or operable to support any one or combination of the HTTP request triggers the processing of the client data, and where the HTTP request indicates for the processing of the client data to include at least one of preparation of the client data or analysis of the client data. Additionally, or alternatively, the processor 600 may be configured or operable to support the response to the HTTP request indicates one or more of that the processing of the client data is successful, that the processing of the client data has failed and a corresponding error code, a notification that the processing of the client data is redirected to an additional device, processed client data, or a timestamp associated with the processing of the client data. Additionally, or alternatively, the processor 600 may be configured or operable to support the HTTP request includes a POST command, and where the custom operation is based on the HTTP request being the POST command. Additionally, or alternatively, the processor 600 may be configured or operable to support the POST command indicates one or more of a type of the client data, a client data preparation criterion, a client data analysis criterion, one or more schedules associated with traffic pattern configurations corresponding to the processing of the client data, or a time period associated with the processing of the client data.

Additionally, or alternatively, the processor 600 may be configured or operable to support the HTTP request includes a GET command, where the non-custom operation is based on the HTTP request being the GET command, and where the non-custom operation is associated with a filter criterion for the processing of the client data. Additionally, or alternatively, the processor 600 may be configured or operable to support the filter criterion corresponds to one or more of a type of the client data, a client data preparation criterion, a client data analysis criterion, one or more schedules associated with traffic pattern configurations corresponding to the processing of the client data, or a time period associated with the processing of the client data. Additionally, or alternatively, the processor 600 may be configured or operable to support the processor 600 is associated with an AIMLE server, and where to transmit the HTTP request, the processor 600 is configured or operable to support to transmit the HTTP request to an AIMLE client.

The processor 600 may be configured to or operable to support at least one controller (e.g., the controller 602) coupled with at least one memory (e.g., the memory 604) and configured to cause the processor to receive an HTTP request that triggers processing of client data, where the HTTP request indicates a custom operation triggering the processing of the client data or a non-custom operation triggering the processing of the client data, process, based on the custom operation or the non-custom operation, the client data, and transmit a response to the HTTP request that indicates an outcome of the processing of the client data.

Additionally, the processor 600 may be configured to or operable to support any one or combination of to process the client data includes at least one of to prepare the client data or to analyze the client data, where the HTTP request indicates for the processing of the client data to include at least one of preparation of the client data or analysis of the client data. Additionally, or alternatively, the processor 600 may be configured or operable to support the response to the HTTP request indicates one or more of that the processing of the client data is successful, that the processing of the client data has failed and a corresponding error code, a notification that the processing of the client data is redirected to an additional device, processed client data, or a timestamp associated with the processing of the client data. Additionally, or alternatively, the processor 600 may be configured or operable to support the HTTP request includes a POST command, and where the custom operation is based on the HTTP request being the POST command. Additionally, or alternatively, the processor 600 may be configured or operable to support the POST command indicates one or more of a type of the client data, a client data preparation criterion, a client data analysis criterion, one or more schedules associated with traffic pattern configurations corresponding to the processing of the client data, or a time period associated with the processing of the client data.

Additionally, or alternatively, the processor 600 may be configured or operable to support the HTTP request includes a GET command, where the non-custom operation is based on the HTTP request being the GET command, and where the non-custom operation is associated with a filter criterion for the processing of the client data. Additionally, or alternatively, the processor 600 may be configured or operable to support the filter criterion corresponds to one or more of a type of the client data, a client data preparation criterion, a client data analysis criterion, one or more schedules associated with traffic pattern configurations corresponding to the processing of the client data, or a time period associated with the processing of the client data. Additionally, or alternatively, the processor 600 may be configured or operable to support to determine, based on an identity associated with a network entity, that the network entity is authorized for the HTTP request. Additionally, or alternatively, the processor 600 may be configured or operable to support to receive the HTTP request from an AIMLE server, and where the processor 600 is associated with an AIMLE client.

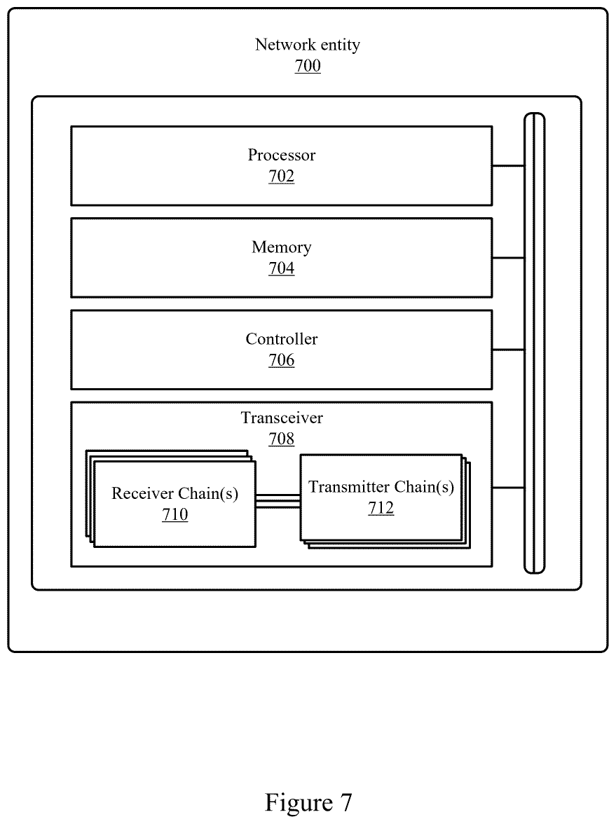

FIG. 7 illustrates an example of an network entity 700 in accordance with aspects of the present disclosure. The network entity 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces. The network entity 700 may be an example of an AIMLE server or any other network entity or device.

The processor 702, the memory 704, the controller 706, or the transceiver 708, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the network entity 700 to perform various functions of the present disclosure.

The memory 704 may include volatile or non-volatile memory. The memory 704 may store computer-readable, computer-executable code including instructions when executed by the processor 702 cause the network entity 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the network entity 700 to perform one or more of the functions described herein (e.g., executing, by the processor 702, instructions stored in the memory 704). For example, the processor 702 may support wireless communication at the network entity 700 in accordance with examples as disclosed herein. The network entity 700 may be configured or operable to support a means for transmitting an HTTP request associated with client data, where the HTTP request indicates a custom operation for triggering processing of the client data or a non-custom operation for triggering the processing of the client data, and receiving a response to the HTTP request that indicates an outcome of the processing of the client data.

Additionally, the network entity 700 may be configured or operable to support any one or combination of the HTTP request triggers the processing of the client data, and where the HTTP request indicates for the processing of the client data to include at least one of preparation of the client data or analysis of the client data. Additionally, or alternatively, the network entity 700 may be configured or operable to support the response to the HTTP request indicates one or more of that the processing of the client data is successful, that the processing of the client data has failed and a corresponding error code, a notification that the processing of the client data is redirected to an additional device, processed client data, or a timestamp associated with the processing of the client data. Additionally, or alternatively, the network entity 700 may be configured or operable to support the HTTP request includes a POST command, and where the custom operation is based on the HTTP request being the POST command. Additionally, or alternatively, the network entity 700 may be configured or operable to support the POST command indicates one or more of a type of the client data, a client data preparation criterion, a client data analysis criterion, one or more schedules associated with traffic pattern configurations corresponding to the processing of the client data, or a time period associated with the processing of the client data.

Additionally, or alternatively, the network entity 700 may be configured or operable to support the HTTP request includes a GET command, where the non-custom operation is based on the HTTP request being the GET command, and where the non-custom operation is associated with a filter criterion for the processing of the client data. Additionally, or alternatively, the network entity 700 may be configured or operable to support the filter criterion corresponds to one or more of a type of the client data, a client data preparation criterion, a client data analysis criterion, one or more schedules associated with traffic pattern configurations corresponding to the processing of the client data, or a time period associated with the processing of the client data. Additionally, or alternatively, the network entity 700 may be configured or operable to support the network entity includes an AIMLE server, and where to transmit the HTTP request, the network entity 700 may be configured or operable to support transmitting the HTTP request to an AIMLE client.

Additionally, or alternatively, the network entity 700 may support at least one memory (e.g., the memory 704) and at least one processor (e.g., the processor 702) coupled with the at least one memory and configured to cause the network entity to transmit an HTTP request associated with client data, where the HTTP request indicates a custom operation for triggering processing of the client data or a non-custom operation for triggering the processing of the client data, and receive a response to the HTTP request that indicates an outcome of the processing of the client data.

Additionally, the network entity 700 may be configured or operable to support any one or combination of the HTTP request triggers the processing of the client data, and where the HTTP request indicates for the processing of the client data to include at least one of preparation of the client data or analysis of the client data. Additionally, or alternatively, the network entity 700 may be configured or operable to support the response to the HTTP request indicates one or more of that the processing of the client data is successful, that the processing of the client data has failed and a corresponding error code, a notification that the processing of the client data is redirected to an additional device, processed client data, or a timestamp associated with the processing of the client data. Additionally, or alternatively, the network entity 700 may be configured or operable to support the HTTP request includes a POST command, and where the custom operation is based on the HTTP request being the POST command. Additionally, or alternatively, the network entity 700 may be configured or operable to support the POST command indicates one or more of a type of the client data, a client data preparation criterion, a client data analysis criterion, one or more schedules associated with traffic pattern configurations corresponding to the processing of the client data, or a time period associated with the processing of the client data.

Additionally, or alternatively, the network entity 700 may be configured or operable to support the HTTP request includes a GET command, where the non-custom operation is based on the HTTP request being the GET command, and where the non-custom operation is associated with a filter criterion for the processing of the client data. Additionally, or alternatively, the network entity 700 may be configured or operable to support the filter criterion corresponds to one or more of a type of the client data, a client data preparation criterion, a client data analysis criterion, one or more schedules associated with traffic pattern configurations corresponding to the processing of the client data, or a time period associated with the processing of the client data. Additionally, or alternatively, the network entity 700 may be configured or operable to support the network entity includes an AIMLE server, and where to transmit the HTTP request, the network entity 700 may be configured or operable to support to transmit the HTTP request to an AIMLE client.

The controller 706 may manage input and output signals for the network entity 700. The controller 706 may also manage peripherals not integrated into the network entity 700. In some implementations, the controller 706 may utilize an operating system such as iOS®, ANDROID®, WINDOWS®, or other operating systems. In some implementations, the controller 706 may be implemented as part of the processor 702.

In some implementations, the network entity 700 may include at least one transceiver 708. In some other implementations, the network entity 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., an LNA) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

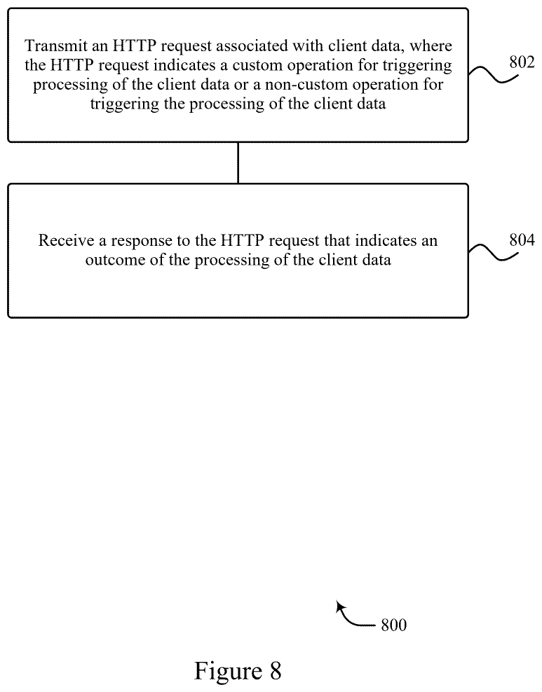

FIG. 8 illustrates a flowchart of a method 800 in accordance with aspects of the present disclosure. The operations of the method may be implemented by a network entity (e.g., an AIMLE server) as described herein. In some implementations, the network entity may execute a set of instructions to control the function elements of the network entity to perform the described functions. It should be noted that the method described herein describes a possible implementation, and that the operations and the steps may be rearranged or otherwise modified and that other implementations are possible.

At 802, the method may include transmitting an HTTP request associated with client data, where the HTTP request indicates a custom operation for triggering processing of the client data or a non-custom operation for triggering the processing of the client data. The operations of 802 may be performed in accordance with examples as described herein. In some implementations, aspects of the operations of 802 may be performed by a network entity as described with reference to FIG. 7.

At 804, the method may include receiving a response to the HTTP request that indicates an outcome of the processing of the client data. The operations of 804 may be performed in accordance with examples as described herein. In some implementations, aspects of the operations of 804 may be performed by a network entity as described with reference to FIG. 7.

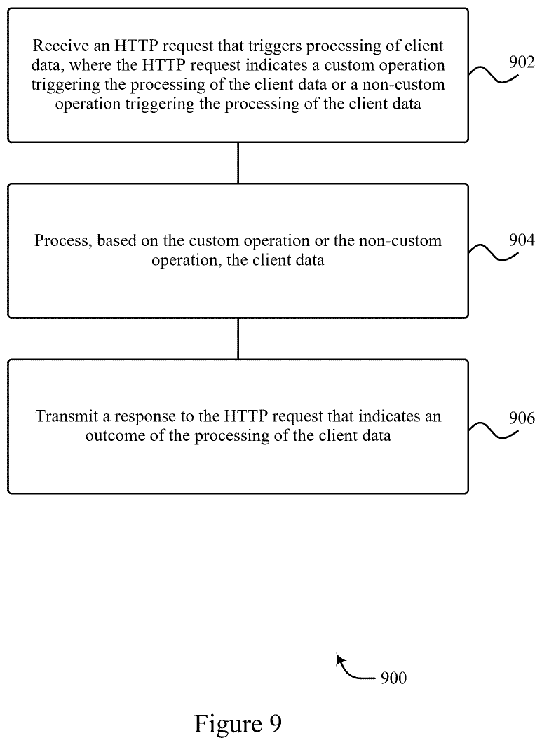

FIG. 9 illustrates a flowchart of a method 900 in accordance with aspects of the present disclosure. The operations of the method may be implemented by a device (e.g., an AIMLE client) as described herein. In some implementations, the device may execute a set of instructions to control the function elements of the device to perform the described functions. It should be noted that the method described herein describes a possible implementation, and that the operations and the steps may be rearranged or otherwise modified and that other implementations are possible.

At 902, the method may include receiving an HTTP request that triggers processing of client data, where the HTTP request indicates a custom operation triggering the processing of the client data or a non-custom operation triggering the processing of the client data. The operations of 902 may be performed in accordance with examples as described herein. In some implementations, aspects of the operations of 902 may be performed by a device as described with reference to FIG. 5.

At 904, the method may include processing, based on the custom operation or the non-custom operation, the client data. The operations of 904 may be performed in accordance with examples as described herein. In some implementations, aspects of the operations of 904 may be performed by a device as described with reference to FIG. 5.

At 906, the method may include transmitting a response to the HTTP request that indicates an outcome of the processing of the client data. The operations of 906 may be performed in accordance with examples as described herein. In some implementations, aspects of the operations of 906 may be performed a device as described with reference to FIG. 5.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and operable to cause the network entity to:
transmit a hypertext transfer protocol (HTTP) request associated with client data, wherein the HTTP request indicates a custom operation for triggering processing of the client data or a non-custom operation for triggering the processing of the client data; and
receive a response to the HTTP request that indicates an outcome of the processing of the client data.

2. The network entity of claim 1, wherein the HTTP request triggers the processing of the client data, and wherein the HTTP request indicates for the processing of the client data to comprise at least one of preparation of the client data or analysis of the client data.

3. The network entity of claim 1, wherein the response to the HTTP request indicates one or more of that the processing of the client data is successful, that the processing of the client data has failed and a corresponding error code, a notification that the processing of the client data is redirected to an additional device, processed client data, or a timestamp associated with the processing of the client data.

4. The network entity of claim 1, wherein the HTTP request comprises a POST command, and wherein the custom operation is based at least in part on the HTTP request being the POST command.

5. The network entity of claim 4, wherein the POST command indicates one or more of a type of the client data, a client data preparation criterion, a client data analysis criterion, one or more schedules associated with traffic pattern configurations corresponding to the processing of the client data, or a time period associated with the processing of the client data.

6. The network entity of claim 1, wherein the HTTP request comprises a GET command, wherein the non-custom operation is based at least in part on the HTTP request being the GET command, and wherein the non-custom operation is associated with a filter criterion for the processing of the client data.

7. The network entity of claim 6, wherein the filter criterion corresponds to one or more of a type of the client data, a client data preparation criterion, a client data analysis criterion, one or more schedules associated with traffic pattern configurations corresponding to the processing of the client data, or a time period associated with the processing of the client data.

8. The network entity of claim 1, wherein the network entity comprises an artificial intelligence machine learning enablement (AIMLE) server, and wherein to transmit the HTTP request, the at least one processor is operable to cause the network entity to transmit the HTTP request to an AIMLE client.

9. A method performed by a network entity, the method comprising:
transmitting a hypertext transfer protocol (HTTP) request associated with client data, wherein the HTTP request indicates a custom operation for triggering processing of the client data or a non-custom operation for triggering the processing of the client data; and
receiving a response to the HTTP request that indicates an outcome of the processing of the client data.

10. A device for wireless communication, comprising:
at least one memory; and
at least one processor coupled with the at least one memory and operable to cause the device to:
receive a hypertext transfer protocol (HTTP) request that triggers processing of client data, wherein the HTTP request indicates a custom operation triggering the processing of the client data or a non-custom operation triggering the processing of the client data;
process, based at least in part on the custom operation or the non-custom operation, the client data; and
transmit a response to the HTTP request that indicates an outcome of the processing of the client data.

11. The device of claim 10, wherein to process the client data, the at least one processor is operable to cause the device to at least one of:
prepare the client data; or
analyze the client data, wherein the HTTP request indicates for the processing of the client data to comprise at least one of preparation of the client data or analysis of the client data.

12. The device of claim 10, wherein the response to the HTTP request indicates one or more of that the processing of the client data is successful, that the processing of the client data has failed and a corresponding error code, a notification that the processing of the client data is redirected to an additional device, processed client data, or a timestamp associated with the processing of the client data.

13. The device of claim 10, wherein the HTTP request comprises a POST command, and wherein the custom operation is based at least in part on the HTTP request being the POST command.

14. The device of claim 13, wherein the POST command indicates one or more of a type of the client data, a client data preparation criterion, a client data analysis criterion, one or more schedules associated with traffic pattern configurations corresponding to the processing of the client data, or a time period associated with the processing of the client data.

15. The device of claim 10, wherein the HTTP request comprises a GET command, wherein the non-custom operation is based at least in part on the HTTP request being the GET command, and wherein the non-custom operation is associated with a filter criterion for the processing of the client data.

16. The device of claim 15, wherein the filter criterion corresponds to one or more of a type of the client data, a client data preparation criterion, a client data analysis criterion, one or more schedules associated with traffic pattern configurations corresponding to the processing of the client data, or a time period associated with the processing of the client data.

17. The device of claim 10, wherein to process the client data, the at least one processor is operable to cause the device to determine, based at least in part on an identity associated with a network entity, that the network entity is authorized for the HTTP request.

18. The device of claim 10, wherein to receive the HTTP request, the at least one processor is operable to cause the device to receive the HTTP request from an artificial intelligence machine learning enablement (AIMLE) server, and wherein the device comprises an AIMLE client.

19. A method performed by a device, the method comprising:
receiving a hypertext transfer protocol (HTTP) request that triggers processing of client data, wherein the HTTP request indicates a custom operation triggering the processing of the client data or a non-custom operation triggering the processing of the client data;
processing, based at least in part on the custom operation or the non-custom operation, the client data; and
transmitting a response to the HTTP request that indicates an outcome of the processing of the client data.

20. The method of claim 19, wherein processing the client data comprises at least one of:
preparing the client data; or
analyzing the client data, wherein the HTTP request indicates for the processing of the client data to comprise at least one of preparation of the client data or analysis of the client data.
